(19) United States
(12) Patent Application Publication
(10) Pub. No.: US 2007/0090944 A1
(43) Pub. Date: Apr. 26, 2007

(54) Home-monitoring system

(76) Inventor: Thomas L. Du Breuil, Ivyland, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/257,787

(22) Filed: Oct. 25, 2005

(51) Int. Cl. G08B 1/00; H04Q 1/30; G08B 25/00; G08B 1/08; G08B 13/00; H04N 7/18

(52) U.S. Cl. 340/531; 340/539.17; 340/524; 340/541; 348/143

(57) ABSTRACT

A method and system for securing neighborhoods against crime. In one system, a short range wireless LAN technology, e.g., WiFi or WiMax, is employed to relay sensor information, including that from cameras, in real-time to a security server in a neighbor's house, which can significantly improve response time. The wireless LAN technology allows higher quality video to be captured by the on-site cameras, and relayed off-site in real-time, preserving the integrity of the data even if a burglar or intruder finds and destroys or steals the on-site security equipment. Modern IP monitoring may be employed to offer additional capabilities and reliability in these systems.

### FIELD OF THE INVENTION

The invention relates to devices for monitoring and security of a set of houses or premises.

### BACKGROUND OF THE INVENTION

Current home monitoring security systems include several classes of products and services. One is the traditional monitored security system 10 (see FIG. 1) which typically includes a professionally-installed set of door and window contact switches, motion sensors, and certain other sensors, e.g., fire alarms and smoke detectors. Referring to FIG. 1, system trips at a user's house 12 automatically trigger an alarm at the alarm company's central monitoring facility 14 via phone line 18 where staff attempt to verify the alarm and call the police via phone line 22 at, e.g., response facility 16. The alarm company's staff may further attempt to notify the homeowner or a business representative to verify that the alarm is not false. These systems are sometimes equipped with a battery backup and a cellular phone network link in order to provide protection against burglars cutting the utility wires prior to entering the home.

These professionally-monitored systems typically cost $20-$40 per month and, despite the central monitoring and verification attempts, still result in numerous false alarm reports to police for various reasons. In addition, average police response time may be greater than 10 minutes, thus allowing ample time for burglars to steal what they want or intruders to cause damage.

Another class of products includes cameras in addition to the sensors typically used in the first class of traditional monitored systems. These systems include, e.g., the Motorola® HM1000® products, available from Motorola®, Inc., of Schaumberg, Ill. Many of these systems are targeted to the “do-it-yourself” homeowner. Some of these systems, like those of Motorola®, support web-monitoring of in-house cameras for a monthly service fee. These systems have certain functionality not present in the first class of systems, including the ability to view the inside of the house to check on, e.g., children or pets. However, in other aspects, these systems do not offer all the functionality of the systems in the first class, and the use of video has other limitations.

For example, uplinking video information over a dialup or cellular network is often difficult due to the low bandwidths available. Moreover, these are easily subverted by burglars, e.g., by cutting the wires.

In either case, the systems are not configured to allow a quick check of the condition of the premises. Neither do they provide for additional types of sensors, e.g., water or electricity monitors. Moreover, data from the sensors or camera is not reliably stored for later viewing.

### BRIEF DESCRIPTION OF THE DRAWINGS

FIG. 1 shows a prior art schematic diagram of a house or premise communicating with an alarm company which in turn communicates with a police station or response facility.

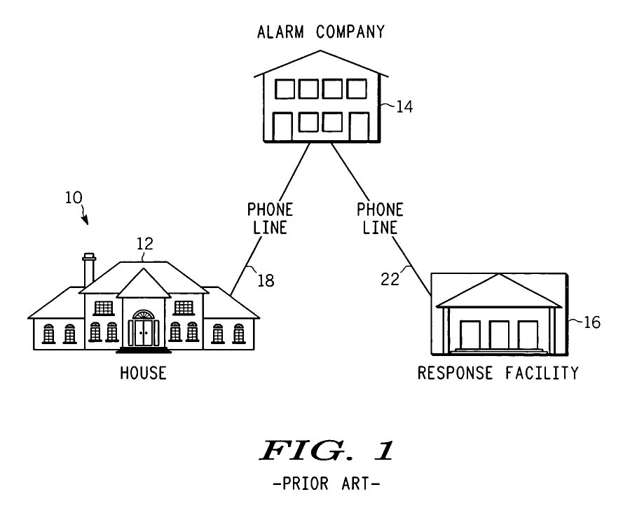

FIG. 2 shows a schematic diagram of an illustrative system, in which a neighborhood having at least two houses communicates via a wireless LAN.

FIG. 3 shows a more detailed diagram of the system of FIG. 2, in which two houses communicate via a wireless LAN.

FIG. 4 shows a flowchart showing actions taken in a monitored premise upon the occurrence of a triggering event.

FIG. 5 shows a flowchart showing actions taken in a monitoring premise upon the occurrence of a triggering event.

### DETAILED DESCRIPTION

In this description, the term “house” or “premise” is used generically to refer to any type of dwelling or building in which users inhabit for any length of time, including businesses or homes. The term “monitored premise” refers to the premise in which a camera or other sensor or data collection device is located. The term “monitoring premise” refers to the premise to which the data from the monitored premise is transmitted. More than one monitoring premise may receive data from the same monitored premise. The monitoring premises are generally nearby the monitored premise, e.g. within the same neighborhood cluster, or within the same LAN or wireless LAN.

The term “real-time” is used here to refer to systems that respond immediately or substantially immediately, at least in terms of data communication. In this context, “real-time” refers to any time period from one video frame time, 1/30th of a second typically, up to a time period sufficient to allow for reliable detection that an event of interest is actually occurring as well as to allow for efficient video coding and transmission. This sufficient time may be, e.g., 15 seconds, 20 seconds, 30 seconds, etc. In addition, depending on the details of the application, a delay can be employed and provided prior to transmission to the monitoring premise within the wireless LAN. Moreover, the data can be stored for any length of time prior to transmission to the monitoring premise within the wireless LAN. Similarly, the transmission of data from the camera or sensor may also be stored at the monitored premise, either in substantially real-time or with any length delay.

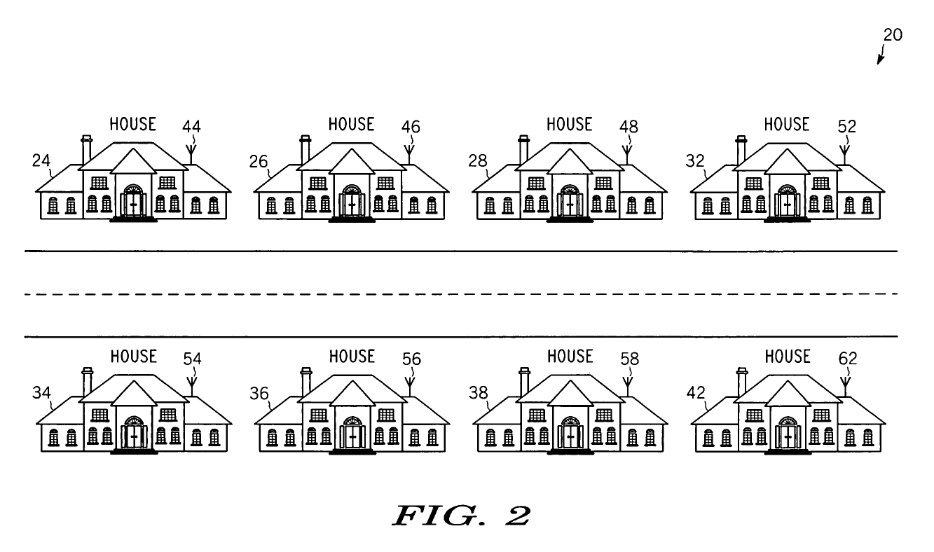

Referring to FIG. 2, an illustrative system is shown in a neighborhood cluster 20. Neighborhood cluster 20 includes any number of houses greater than or equal to two, as long as a wireless LAN or other such system can establish and maintain communications between the houses in the cluster. In FIG. 2, neighborhood cluster 20 includes a number of houses 24-42 having wireless antennas 44-62. Of course, these antennas are shown schematically in the figure as located on top of the house, but in an actual wireless LAN would typically be located inside the house. In other systems, of course, FIG. 2 may pertain to a business park or other grouping of businesses.

The system employs a short range wireless LAN technology, e.g., WiFi or WiMax, or the like, to relay sensor information, including that from cameras, in real-time to a terminal, computer, television, sound or audio system, or other monitor in a monitoring premise via a wireless LAN. The wireless LAN technology allows data to be captured by the on-site camera or sensor and relayed off-site in substantially real-time, preserving the integrity of the data even if a burglar finds and destroys the on-site security equipment. In other systems, as noted above, the transmission of data from the monitored premise to a monitoring premise within the wireless LAN may be subject to a delay.

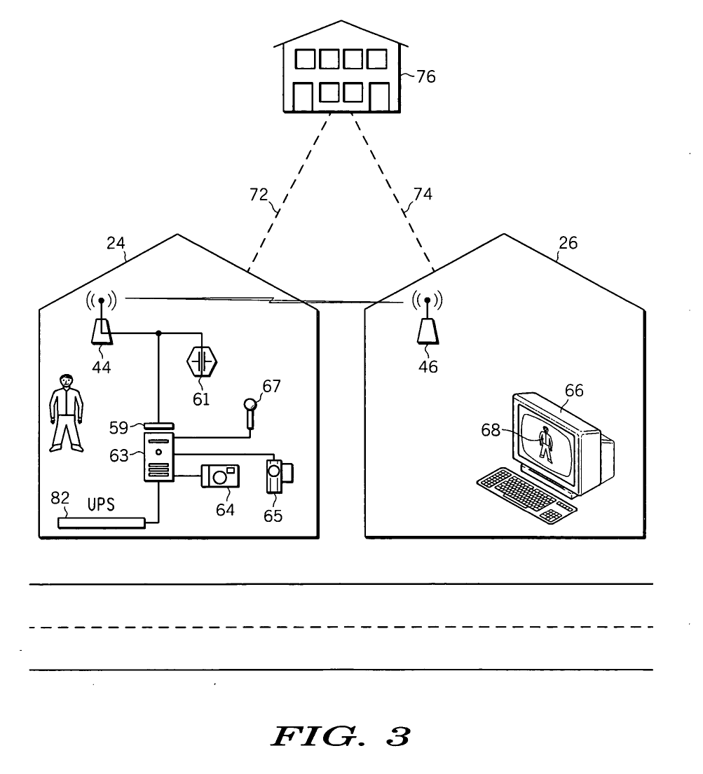

For simplicity, FIG. 3 focuses on the interaction between two of the houses, houses 24 and 26. A data collection device, e.g., a camera or sensor, such as a still camera 64 or a video camera 65, e.g., a webcam, views a scene within the house. The camera may have the optional capability of being panned or tilted or otherwise directed as desired by the user in the monitoring premise. A controller 59 in the monitored premise receives and formats the data from the camera or sensor. The controller 59 may be part of a residential gateway or processor, and is connected to a wireless antenna 44 which broadcasts the signal to the neighborhood. Alternatively, the signal may be encrypted and encoded such that only one or a subset of houses within the wireless LAN receive and are able to decrypt the signal; such are termed here the recipient or recipients of the signal.

Besides a camera, a sensor 61 such as a smoke detector, water or moisture detector, sound detector, e.g., microphone 67, electricity monitor, magnetic switches on doors or windows, motion detectors, or other such sensors may be employed to test other conditions of the premise. The water detector could detect floods; the electricity monitor could detect power outages, etc.

The monitoring premise 26 receives the signal via a wireless antenna 46. The signal is routed to a residential gateway, processor, or server 66 in the monitoring premise, which then stores and optionally displays a signal indicative of the scene viewed by the camera 64 or by the sensor 61, as described in more detail below. The signal may also be stored locally on a system 63 at premise 24.

The recipient can vary depending on the action required. In the most passive systems, the action of the recipient is merely to house an off-site computer or other data storage device that stores video or sensor data of a premise. Systems such as these can be of great value in the aftermath of a burglary or other such happening.

In a more active role, the recipient may perform a degree of investigation in response to a triggering event. For example, if a sensor detects smoke, the recipient may view the premise, e.g., through a window, to see if there is a fire, and if so the recipient may notify the fire department. The same may be true if a magnetic switch on a door detects a “break-in”. The recipient may be able to determine visually that the alarm was tripped by, e.g., a known family member, and in this case the police authorities need not be called. In this way, the determination of the cause of a triggering event may be determined far more quickly than alarm system companies that rely only on police calls or calls to a homeowner or business-owner.

For these reasons, the recipient may vary based on time-of-day, e.g., to accommodate the varying work schedules of neighbors. Further, the recipient may also vary based on the type of signal; e.g., an elderly neighbor may not be desired to investigate a break-in but they may be well-suited to investigate a water leak. A controller with a look-up table or other database may be provided within the system to determine who the proper recipient is, given the day, time-of-day, type of signal, and any other desired factors. Moreover, a backup recipient may be provided in the look-up table in case the first recipient is unavailable. By appropriate communication between the houses, the system may have a degree of intelligence to enable the same to guess whether a particular recipient is available or not; for example, if a potential recipient has their own alarm set or enabled, they are likely not available to respond to a neighbor alarm. In these types of systems, the recipient has to verify that they have received the signal, either by pushing a button or by another type of response in an active response system. If the recipient fails to do so, the system alerts the next appropriate recipient, if available. For purposes of data redundancy, the data may stored at the first recipient's premise, at the monitored premise, at the second recipient's premise, or at any combination of these. The user of the monitored premise may be notified of which signals were sent and to whom, and if recipients were unavailable.

If the signal is sent at a time when a user or neighbor in the monitoring premise is asleep or otherwise fails to respond, in some illustrative systems the residential gateway in the monitoring premise may turn on or flash the lights in the house, turn on the television, or provide some signal to the recipient that a signal has been sent.

Assuming the recipient is likely awake, the residential gateway may determine if a PC or television is turned on, and flash a banner pertaining to the signal on one of the same. That is, the residential gateway may preferentially use those types of monitors to display the signal or an alert for the signal.

In an illustrative system, a signal may be transmitted continuously from the monitored premise to the monitoring premise. The data at the monitoring premise may be overwritten at a desired point to save disk storage space. In an alternative illustrative system, a signal may be transmitted from the monitored premise to the monitoring premise only upon the occurrence of a triggering event. The triggering event may be, e.g., a reading from a sensor that is out of a predetermined range, a magnetic switch opening due to the opening of a door or window, etc. The triggering event may also be determined from the camera: image processing software may detect the change of an image, e.g., an intruder passing in front of a camera.

As shown in FIG. 3, a backup network may be provided in case of failures in the wireless short-range transmissions. In particular, communications lines 72 and 74 can connect to a central office 76. Examples of such lines include cellular, pager, mobile, satellite, phone, cable, broadband or other such data networks.

In a further illustrative system, encryption is employed to secure the information against improper use. In particular, encryption is employed to secure the transmitted content. Encryption may further be employed on the monitoring premise computer or server. In this way, for systems in which user intervention by someone in a monitoring premise is undesired, the owner of the security system holds the security key or passphrase so that only they can access their own content. Such communications can be, e.g., via the short-range wireless LAN. In addition, the wireless LAN itself may be secured, so that only houses in the neighborhood cluster can log onto the same.

Symmetrical or clustered systems are generally useful for this neighborhood application. In this case, all participants have compatible systems of sensors, cameras, and content storage servers.

As an example, a first and second neighbor would each have compatible systems. In the first neighbor's house, the first neighbor could view their own security/monitoring content securely, which content is present on the server of the second neighbor, and vice-versa. In the same way, such content could be made accessible through the internet via a browser while still maintaining the encryption for privacy protection. In fact, multiple homes could be present in a cluster, providing additional redundancy of both the security system itself through multiple servers, and via the additional neighbors who might be at home at the time of an alarm to investigate its cause.

In another illustrative system, the system is hardened against failure of the home's phone, data lines, and electrical power system by including a battery backup 82. The battery backup system need not be overly large; in fact, a common backup capability, 15 minutes or so, would be adequate for many purposes, as the system would likely trigger alarms and capture appropriate video or sensor information within five minutes of an intruder disrupting any of these services into a home. Such a battery backup facility would of course be beneficial to implement in every house or premise in the neighborhood cluster, although the same is not required.

The servers that store the results may be particularly reliable, e.g., self-contained and generally not part of a general purpose home computer. In addition, the same should be protected via a firewall at least against attacks through its wireless communication port, where all traffic of interest should be encrypted, any other internet or phone ports, and the same may have robust internal surge suppression on the power line and other network interfaces as well.

Certain illustrative methods are now described. Combinations of these methods may often be employed. As a precondition to the use of these methods, it is understood that the alarm system is enabled.

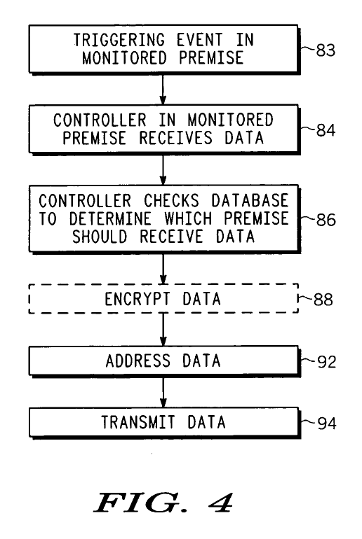

In one illustrative method, as shown in FIG. 4, a monitored premise experiences a triggering event (step 83). The triggering event may be that a value determined by a sensor has gone out of range, a camera or motion detector has sensed movement, etc. The monitored premise may also be monitored substantially continuously. In any case, a controller 59 in the monitored premise receives the data from the camera or sensor (step 84). The controller checks its database or look-up table to determine which house or premise should receive the data (step 86). The data is optionally encrypted (step 88). The data is then addressed such that the proper recipient receives the data (step 92). The data may then be transmitted (step 94). The data may be addressed to multiple recipients.

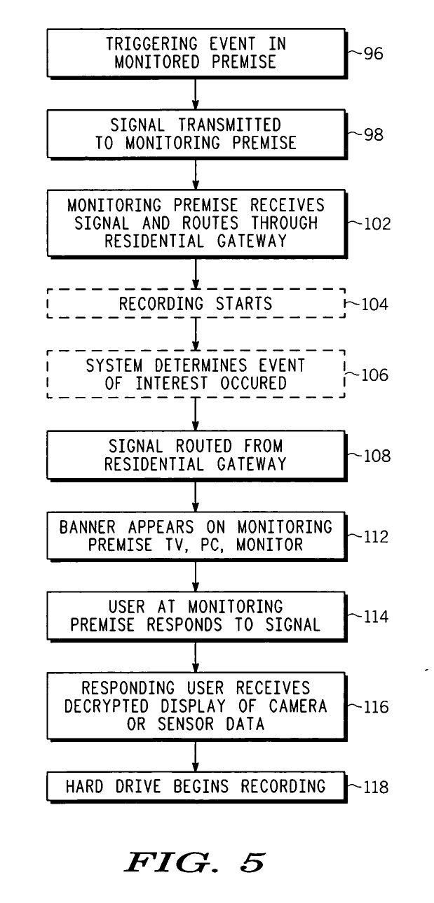

FIG. 4 showed the situation at the monitored premise. The situation at the monitoring premise is discussed below in connection with FIG. 5.

A triggering event occurs in the monitored premise (step 96). A signal corresponding to the triggering event is transmitted to the monitoring premise (step 98) by a wireless transmitter/receiver at the monitored premise. The monitoring premise receives the signal at its wireless transmitter/receiver and routes the signal through a residential gateway or controller (step 102).

Depending on the configuration of the system, the recording of the signal corresponding to the triggering event may optionally occur at this point (step 104). Alternatively, another type of system may record the signal from the monitored premise substantially continuously.

Another optional step is for the system to determine if an event of interest has occurred (step 106). That is, the system may determine that a situation requiring user input or response has occurred. This may pertain to a sensor value being out of range, a motion detected, etc. Of course, the system may also be set up such that only such events give rise to triggering events, and then this step 106 would be unnecessary.

Assuming an event of interest has occurred, the signal is routed from the residential gateway (step 108) and the same causes some notification of a user at the monitoring premise (step 112). For example, a banner may appear on a PC monitor or on a television or other monitor, or an alarm may play from a connected audio system. The system at the monitoring premise, if sophisticated, could determine which appliances are currently “on” and thus route the signal to those appliances in particular, increasing the chance of a response. Next, the recipient at the monitoring premise responds to the signal (step 114), e.g., by pressing a button, so as to indicate they are available to investigate or take some sort of action. Following the response, the recipient receives a decrypted display pertaining to the camera view or to sensor data (step 116). This in turn causes the hard drive at the monitoring premise to begin recording, if it has not done so already (step 118). Of course, devices other than hard drives could also be used, as could any device capable of storing information. In any case, the data is then available for future reference by the user or owner of the monitored premise.

It should be noted that the description above refers to specific examples of the invention, but that the scope of the invention is to be limited only by the scope of the claims appended hereto.

1. A method for monitoring a premise, comprising:
a. collecting data about a premise;
b. communicating the collected data in substantially real-time to a monitoring premise via a wireless LAN; and
c. storing the data at the another premise.

2. The method of claim 1, wherein the results are made available at a terminal at the monitoring premise.

3. The method of claim 1, further comprising storing the data at the monitoring premise.

4. The method of claim 1, further comprising encrypting the results.

5. The method of claim 1, wherein the data is video data or audio data.

6. The method of claim 1, wherein the data is data from a sensor.

7. The method of claim 1, wherein the data is communicated substantially continuously.

8. The method of claim 1, wherein the data is communicated upon an occurrence of a triggering event.

9. The method of claim 8, wherein the triggering event is when the collected data has values outside a predetermined acceptable range.

10. A system for use in monitoring a premise, comprising:
a. a data collection device for installation in a premise;
b. a processor coupled to the data collection device to receive data from the data collection device and to format the received data;
c. a first wireless transmitter coupled to the processor to receive the formatted data from the processor and to broadcast the data to a wireless receiver.

11. The system of claim 10, wherein said data collection device is a camera or a microphone.

12. The system of claim 10, wherein said data collection device is a sensor.

13. The system of claim 10, further comprising a circuit implemented in hardware or software for encrypting the results.

14. A system for use in monitoring a neighborhood cluster, comprising:
a. a plurality of data collection devices for installation in a plurality of premises;
b. a plurality of wireless transmitter/receivers, each of said plurality of wireless transmitter/receivers for installation at each of the plurality of premises, each of said plurality of wireless transmitter/receivers for connection to at least one of the plurality of data collection devices, each of said plurality of wireless transmitter/receivers capable of sending signals from the corresponding data collection device to others of the wireless transmitter/receivers in the plurality of premises, and each of said plurality of wireless transmitter/receivers capable of receiving signals from others of the plurality of wireless transmitter/receivers disposed in the neighborhood cluster.

15. The system of claim 14, wherein said data collection device is a camera or microphone.

16. The system of claim 14, wherein said data collection device is a sensor.

17. The system of claim 14, further comprising a circuit implemented in hardware or software for encrypting the results.

18. The system of claim 14, wherein said plurality of wireless transmitter/receivers are configured to send signals substantially continuously.

19. The system of claim 14, wherein said plurality of wireless transmitter/receivers are configured to send signals upon the occurrence of a triggering event.

20. The method of claim 19, wherein the triggering event is when the collected data has values outside a predetermined acceptable range.
